(19) United States
(12) Patent Application Publication
(10) Pub. No.: US 2015/0311696 A1
(43) Pub. Date: Oct. 29, 2015

(54) SYSTEM AND METHOD FOR PROTECTING ELECTRICAL MACHINES

(71) Applicants: Huibin ZHU, Schenectady, NY (US); Allen Michael RITTER, Roanoke, VA (US); Einar Vaughn LARSEN, Schenectady, NY (US); Anthony Michael KLODOWSKI, Salem, VA (US); Zhuohui TAN, Shanghai (CN); Wenqiang YANG, Pudong, Shanghai (CN); Sidney Allen BARKER, Salem, VA (US); Xueqin WU, Pudong, Shanghai (CN)

(72) Inventors: Huibin ZHU, Schenectady, NY (US); Allen Michael RITTER, Roanoke, VA (US); Einar Vaughn LARSEN, Schenectady, NY (US); Anthony Michael KLODOWSKI, Salem, VA (US); Zhuohui TAN, Shanghai (CN); Wenqiang YANG, Pudong, Shanghai (CN); Sidney Allen BARKER, Salem, VA (US); Xueqin WU, Pudong, Shanghai (CN)

(73) Assignee: General Electric Company, Schenectady, NY (US)

(21) Appl. No.: 14/419,754

(22) PCT Filed: Aug. 30, 2012
(86) PCT No.: PCT/CN2012/080790

§ 371 Date: May 4, 2015

(51) Int. Cl. H02H 3/20

(52) U.S. Cl. CPC H02H 3/207

(57) ABSTRACT

In one aspect, a method for protecting one or more electrical machines during a grid fault on an electrical system connected with the one or more electrical machines is provided. The method includes detecting a grid fault on an electrical system; taking one or more first actions from a first set of actions based on detected grid fault on the electrical system; detecting at least one operating condition of the electrical system after taking one or more first actions from the first set of actions based on the detected grid fault on the electrical system; and taking one or more second actions from a second set of actions based on the detected at least one operating condition of the electrical system.

### FIELD OF THE INVENTION

The present subject matter relates generally to electrical machines and, more particularly, to a system and method for protecting one or more electrical machines during a grid fault on an electrical system connected with the one or more electrical machines.

### BACKGROUND OF THE INVENTION

Generally, a wind turbine generator includes a turbine that has a rotor that includes a rotatable hub assembly having multiple blades. The blades transform mechanical wind energy into a mechanical rotational torque that drives one or more generators via the rotor. The generators are generally, but not always, rotationally coupled to the rotor through a gearbox. The gearbox steps up the inherently low rotational speed of the rotor for the generator to efficiently convert the rotational mechanical energy to electrical energy, which is fed into a utility grid via at least one electrical connection. Gearless direct drive wind turbine generators also exist. The rotor, generator, gearbox and other components are typically mounted within a housing, or nacelle, that is positioned on top of a base that may be a truss or tubular tower.

Some wind turbine generator configurations include doubly fed induction generators (DFIGs). Such configurations may also include power converters that are used to transmit generator excitation power to a wound generator rotor from one of the connections to the electric utility grid connection. Moreover, such converters, in conjunction with the DFIG, also transmit electric power between the utility grid and the generator as well as transmit generator excitation power to a wound generator rotor from one of the connections to the electric utility grid connection. Alternatively, some wind turbine configurations include, but are not limited to, alternative types of induction generators, permanent magnet (PM) synchronous generators and electrically-excited synchronous generators and switched reluctance generators.

These alternative configurations may also include power converters that are used to convert the frequencies as described above and transmit electrical power between the utility grid and the generator. In some instances, sources of electrical generation such as the wind turbine generators described above may be located in remote areas far from the loads they serve. Typically, these sources of generation are connected to the electrical grid through an electrical system such as long transmission lines. These transmission lines are connected to the grid using one or more breakers. In some instances, a grid fault can occur on these electrical systems. Such grid faults may cause high voltage events, low voltage events, zero voltage events, and the like, that may detrimentally affect the one or more electrical machines if protective actions are not taken. In some instances, these grid faults can be caused by opening of one or more phase conductors of the electrical system resulting in islanding of at least one of the one or more electrical machines. Islanding of these electrical machines by sudden tripping of the transmission line breaker at the grid side or otherwise opening these transmission lines while the source of generation is under heavy load may result in an overvoltage on the transmission line that can lead to damage to the source of generation or equipment associated with the source of generation such as converters and inverters. Islanding generally requires disconnecting at least a portion of the affected one or more electrical machines from the electrical system to prevent damaging the electrical machine or equipment associated with the electrical machine. However, in other instances, the grid fault may not be islanding and may be a short term aberration to the electrical system. In these instances, it is desirous to keep the affected electrical machines connected to the electrical system and to institute ride-through procedures such as, for example, high voltage ride through (HVRT), low voltage ride through (LVRT) and zero voltage ride through (ZVRT). Exemplary systems and methods for HVRT, ZVRT and LVRT are described in U.S. Patent Publication U.S. 20120133343 A1 (U.S. application Ser. No. 13/323309) filed Dec. 12, 2011; U.S. Pat. No. 7,321,221 issued Jan. 22, 2008; and U.S. Pat. No. 6,921,985 issued Jul. 26, 2005, respectively, which are fully incorporated herein by reference and made a part hereof.

Failure to properly detect and manage the occurrence of islanding events in wind turbines or other power generator systems can be very damaging to those systems, especially when the power generation system is using a doubly fed induction generator typology. When an upstream breaker opens and leaves the wind farm or other power generation system isolated from the grid, the ac voltage seen by the wind farm can reach dangerous levels within a few milliseconds. This high ac voltage is more extreme on systems where the remaining connection to the grid has substantial length of power lines that are seen as a shunt capacitance. The event also has potential for a higher degree of damage as the power output of the individual wind turbines increases, for instance, if they are in an overload condition during high winds.

Accordingly, an improved system and/or method that provides for protecting one or more electrical machines during a grid fault on an electrical system connected with the one or more electrical machines would be welcomed in the technology.

### BRIEF DESCRIPTION OF THE INVENTION

In one aspect, a method for protecting one or more electrical machines during a grid fault on an electrical system connected with the one or more electrical machines is provided. The method includes detecting a grid fault on an electrical system, wherein detecting the grid fault comprises detecting whether the grid fault comprises a high voltage event or another grid fault event; taking one or more first actions from a first set of actions based on the detected grid fault on the electrical system; detecting at least one operating condition of the electrical system after taking one or more first actions from the first set of actions based on the detected grid fault on the electrical system; and taking one or more second actions from a second set of actions based on the detected at least one operating condition of the electrical system.

In another aspect, another method for protecting one or more electrical machines during a grid fault on an electrical system connected with the one or more electrical machines is provided. The method includes connecting one or more electrical machines to an alternating current (AC) electric power system, wherein the AC electric power system is configured to transmit at least one phase of electrical power to the one or more electrical machines or to receive at least one phase of electrical power from the one or more electrical machines; electrically coupling at least a portion of a control system to at least a portion of the AC electric power system; coupling at least a portion of the control system in electronic data communication with at least a portion of the one or more electrical machines; detecting a grid fault of the AC electric power system based on one or more conditions monitored by the control system wherein detecting the grid fault on the AC electric power system comprises detecting whether the grid fault comprises a high voltage event or another grid fault event; taking one or more first actions, by the control system, from a first set of actions based on the detected grid fault on the AC electric power system; detecting, by the control system, at least one operating condition of the AC electric power system after taking one or more first actions from the first set of actions based on the detected grid fault on the AC electric power system; and taking one or more second actions, by the control system, from a second set of actions based on the at least one detected operating condition of the AC electric power system.

In yet another aspect, a system for protecting one or more electrical machines during a grid fault on an electrical system connected with the one or more electrical machines is provided. The system includes one or more electrical machines connected to an alternating current (AC) electric power system, wherein the AC electric power system is configured to transmit at least one phase of electrical power to the one or more electrical machines or to receive at least one phase of electrical power from the one or more electrical machines; and a control system, wherein the control system is electrically coupled to at least a portion of the AC electric power system and at least a portion of the control system is coupled in electronic data communication with at least a portion of the one or more electrical machines, and wherein the control system comprises a controller and the controller is configured to: detect a grid fault on an the AC electric power system wherein detecting the grid fault on the electrical system comprises detecting whether the grid fault comprises a high voltage event or another grid fault event; take one or more first actions from a first set of actions based on the detected grid fault on the electrical system; detect at least one operating condition of the AC electric power system after taking one or more first actions from the first set of actions based on the detected grid fault on the AC electric power system; and take one or more second actions from a second set of actions based on the detected at least one operating condition of the AC electric power system.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of embodiments of the present invention, including the best mode thereof, directed to one of ordinary skill in the art, is set forth in the specification, which makes reference to the appended figures, in which:

FIG. 1 is a schematic view of an exemplary wind turbine generator;

FIG. 2 is a schematic view of an exemplary electrical and control system that may be used with the wind turbine generator shown in FIG. 1;

FIG. 3 illustrates a block diagram of one embodiment of suitable components that may be included within an embodiment of a controller, or any other computing device that receives signals indicating a grid fault in accordance with aspects of the present subject matter;

FIG. 4 is a flowchart illustrating an embodiment of a method of protecting one or more electrical machines during a grid fault on an electrical system connected with the one or more electrical machines such as wind turbine generators;

FIG. 5A illustrates an exemplary control scheme for a rotor converter;

FIG. 5B illustrates an exemplary control scheme of a line converter;

FIG. 6 illustrates an embodiment of a rotor voltage clamp control schematic for protecting a DFIG by clamping excitation voltage of the rotor; and

FIG. 7 is a flowchart illustrating another embodiment of a method of protecting one or more electrical machines during a grid fault on an electrical system connected with the one or more electrical machines such as wind turbine generators.

### DETAILED DESCRIPTION OF THE INVENTION

Before the present methods and systems are disclosed and described, it is to be understood that the methods and systems are not limited to specific synthetic methods, specific components, or to particular compositions. It is also to be understood that the terminology used herein is for describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

Generally disclosed herein are systems and methods of protecting one or more electrical machines during a grid fault on an electrical system connected with the one or more electrical machines. Such electrical machines can include, for example, electric motors, electric generators including, for example, wind turbine generators, solar/photovoltaic generation, and the like, and any ancillary equipment associated with such electric machines. In one aspect, embodiments of the present invention disclose systems and methods to rapidly detect a grid fault on an electrical system connected to one or more wind turbine generators, determine the type of grid fault that has occurred, take actions from a first set of actions based on the determined grid fault type to protect the one or more wind turbine generators and any ancillary equipment from electrical transients caused by the grid fault, islanding event, detect at least one operating condition of the electrical system after taking one or more first actions from the first set of actions based on the determined type of grid fault on the electrical system, and take one or more second actions from a second set of actions based on the detected at least one operating condition of the electrical system.

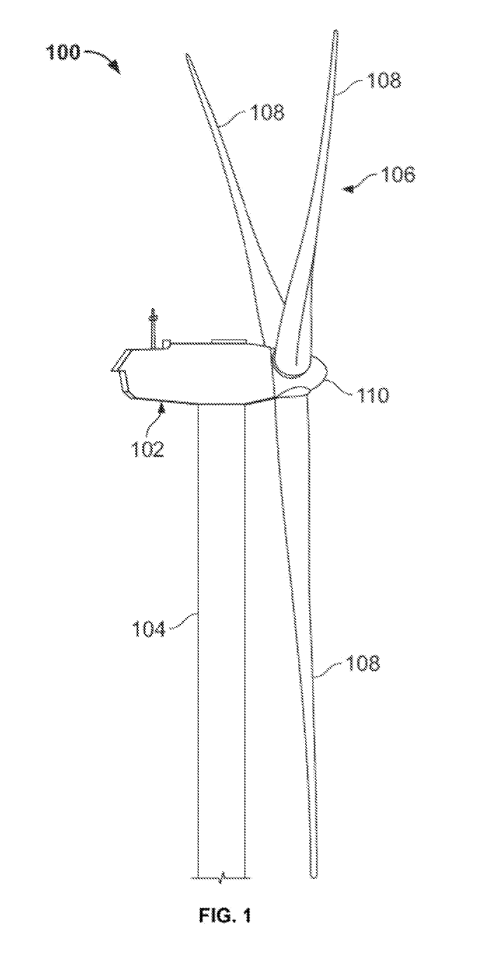

FIG. 1 is a schematic view of an exemplary wind turbine generator 100. The wind turbine 100 includes a nacelle 102 housing a generator (not shown in FIG. 1). Nacelle 102 is mounted on a tower 104 (a portion of tower 104 being shown in FIG. 1). Tower 104 may be any height that facilitates operation of wind turbine 100 as described herein. Wind turbine 100 also includes a rotor 106 that includes three rotor blades 108 attached to a rotating hub 110. Alternatively, wind turbine 100 includes any number of blades 108 that facilitate operation of wind turbine 100 as described herein. In the exemplary embodiment, wind turbine 100 includes a gearbox (not shown in FIG. 1) rotatingly coupled to rotor 106 and a generator (not shown in FIG. 1).

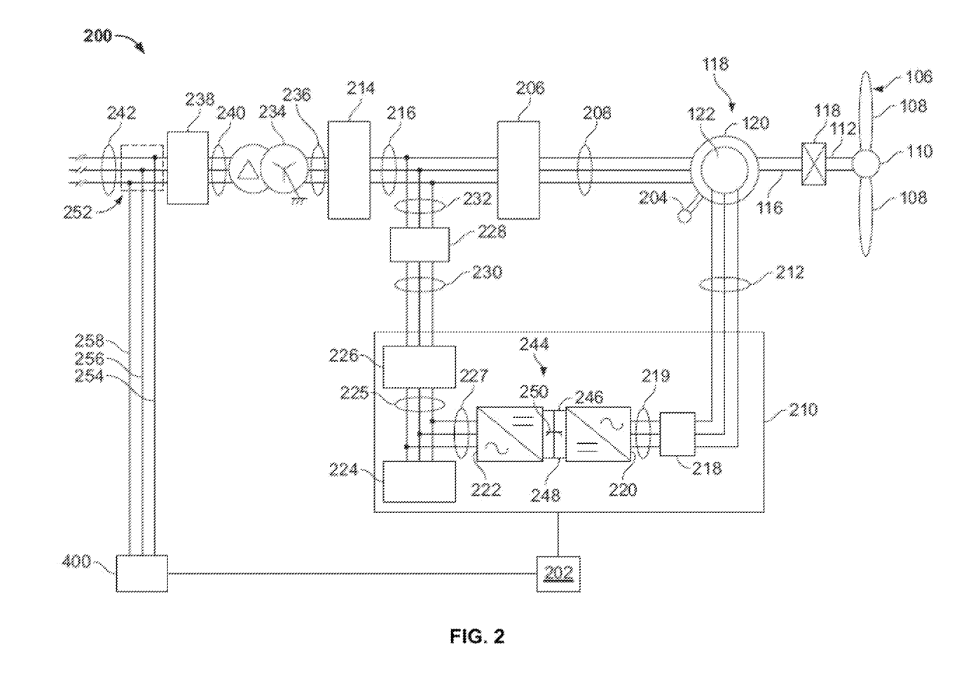

FIG. 2 is a schematic view of an exemplary electrical and control system 200 that may be used with wind turbine generator 100 (shown in FIG. 1). Rotor 106 includes plurality of rotor blades 108 coupled to rotating hub 110. Rotor 106 also includes a low-speed shaft 112 rotatably coupled to hub 110. Low-speed shaft is coupled to a step-up gearbox 114. Gearbox 114 is configured to step up the rotational speed of low-speed shaft 112 and transfer that speed to a high-speed shaft 116. In the exemplary embodiment, gearbox 114 has a step-up ratio of approximately 70:1. For example, low-speed shaft 112 rotating at approximately 20 revolutions per minute (20) coupled to gearbox 114 with an approximately 70:1 step-up ratio generates a high-speed shaft 116 speed of approximately 1400 rpm. Alternatively, gearbox 114 has any step-up ratio that facilitates operation of wind turbine 100 as described herein. Also, alternatively, wind turbine 100 includes a direct-drive generator wherein a generator rotor (not shown in FIG. 1) is rotatingly coupled to rotor 106 without any intervening gearbox.

High-speed shaft 116 is rotatably coupled to generator 118. In the exemplary embodiment, generator 118 is a wound rotor, synchronous, 60 Hz, three-phase, doubly-fed induction generator (DFIG) that includes a generator stator 120 magnetically coupled to a generator rotor 122. Alternatively, generator 118 is any generator of any number of phases that facilitates operation of wind turbine 100 as described herein.

Electrical and control system 200 includes a controller 202. Controller 202 includes at least one processor and a memory, at least one processor input channel, at least one processor output channel, and may include at least one computer (none shown in FIG. 2). As used herein, the term computer is not limited to just those integrated circuits referred to in the art as a computer, but broadly refers to a processor, a microcontroller, a microcomputer, a programmable logic controller (PLC), an application specific integrated circuit, and other programmable circuits (none shown in FIG. 2), and these terms are used interchangeably herein. In the exemplary embodiment, memory may include, but is not limited to, a computer-readable medium, such as a random access memory (RAM) (none shown in FIG. 2). Alternatively, a floppy disk, a compact disc—read only memory (CD-ROM), a magneto-optical disk (MOD), and/or a digital versatile disc (DVD) (none shown in FIG. 2) may also be used. Also, in the exemplary embodiment, additional input channels (not shown in FIG. 2) may be, but not be limited to, computer peripherals associated with an operator interface such as a mouse and a keyboard (neither shown in FIG. 2). Alternatively, other computer peripherals may also be used that may include, for example, but not be limited to, a scanner (not shown in FIG. 2). Furthermore, in the exemplary embodiment, additional output channels may include, but not be limited to, an operator interface monitor (not shown in FIG. 2).

Processors for controller 202 process information transmitted from a plurality of electrical and electronic devices that may include, but not be limited to, speed and power transducers, current transformers and/or current transducers, breaker position indicators, potential transformers and/or voltage transducers, and the like. RAM and storage device store and transfer information and instructions to be executed by the processor. RAM and storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

Electrical and control system 200 also includes generator rotor tachometer 204 that is coupled in electronic data communication with generator 118 and controller 202. Generator stator 120 is electrically coupled to a stator synchronizing switch 206 via a stator bus 208. In the exemplary embodiment, to facilitate the DFIG configuration, generator rotor 122 is electrically coupled to a bi-directional power conversion assembly 210 via a rotor bus 212. Alternatively, system 200 is configured as a full power conversion system (not shown) known in the art, wherein a full power conversion assembly (not shown) that is similar in design and operation to assembly 210 is electrically coupled to stator 120 and such full power conversion assembly facilitates channeling electrical power between stator 120 and an electric power transmission and distribution grid (not shown). Stator bus 208 transmits three-phase power from stator 120 and rotor bus 212 transmits three-phase power from rotor 122 to assembly 210. Stator synchronizing switch 206 is electrically coupled to a main transformer circuit breaker 214 via a system bus 216.

Assembly 210 includes a rotor filter 218 that is electrically coupled to rotor 122 via rotor bus 212. Rotor filter 218 is electrically coupled to a rotor-side, bi-directional power converter 220 via a rotor filter bus 219. Converter 220 is electrically coupled to a line-side, bi-directional power converter 222. Converters 220 and 222 are substantially identical. Power converter 222 is electrically coupled to a line filter 224 and a line contactor 226 via a line-side power converter bus 223 and a line bus 225. In the exemplary embodiment, converters 220 and 222 are configured in a three-phase, pulse width modulation (PWM) configuration including insulated gate bipolar transistor (IGBT) switching devices (not shown in FIG. 2) that “fire” as is known in the art. Alternatively, converters 220 and 222 have any configuration using any switching devices that facilitate operation of system 200 as described herein. Assembly 210 is coupled in electronic data communication with controller 202 to control the operation of converters 220 and 222.

Line contactor 226 is electrically coupled to a conversion circuit breaker 228 via a conversion circuit breaker bus 230. Circuit breaker 228 is also electrically coupled to system circuit breaker 214 via system bus 216 and connection bus 232. System circuit breaker 214 is electrically coupled to an electric power main transformer 234 via a generator-side bus 236. Main transformer 234 is electrically coupled to a grid circuit breaker 238 via a breaker-side bus 240. Grid breaker 238 is connected to an electric power transmission and distribution grid via a grid bus 242.

In the exemplary embodiment, converters 220 and 222 are coupled in electrical communication with each other via a single direct current (DC) link 244. Alternatively, converters 220 and 222 are electrically coupled via individual and separate DC links (not shown in FIG. 2). DC link 244 includes a positive rail 246, a negative rail 248, and at least one capacitor 250 coupled therebetween. Alternatively, capacitor 250 is one or more capacitors configured in series or in parallel between rails 246 and 248.

System 200 can further include a phase-locked loop (PLL) regulator 400 that is configured to receive a plurality of voltage measurement signals from a plurality of voltage transducers 252. In the exemplary embodiment, each of three voltage transducers 252 are electrically coupled to each one of the three phases of bus 242. Alternatively, voltage transducers 252 are electrically coupled to system bus 216. Also, alternatively, voltage transducers 252 are electrically coupled to any portion of system 200 that facilitates operation of system 200 as described herein. PLL regulator 400 is coupled in electronic data communication with controller 202 and voltage transducers 252 via a plurality of electrical conduits 254, 256, and 258. Alternatively, PLL regulator 400 is configured to receive any number of voltage measurement signals from any number of voltage transducers 252, including, but not limited to, one voltage measurement signal from one voltage transducer 252. Controller 202 can also receive any number of current feedbacks from current transformers or current transducers that are electrically coupled to any portion of system 200 that facilitates operation of system 200 as described herein such as, for example, stator current feedback from stator bus 208, grid current feedback from generator side bus 236, and the like.

During operation, wind impacts blades 108 and blades 108 transform mechanical wind energy into a mechanical rotational torque that rotatingly drives low-speed shaft 112 via hub 110. Low-speed shaft 112 drives gearbox 114 that subsequently steps up the low rotational speed of shaft 112 to drive high-speed shaft 116 at an increased rotational speed. High speed shaft 116 rotatingly drives rotor 122. A rotating magnetic field is induced within rotor 122 and a voltage is induced within stator 120 that is magnetically coupled to rotor 122. Generator 118 converts the rotational mechanical energy to a sinusoidal, three-phase alternating current (AC) electrical energy signal in stator 120. The associated electrical power is transmitted to main transformer 234 via bus 208, switch 206, bus 216, breaker 214 and bus 236. Main transformer 234 steps up the voltage amplitude of the electrical power and the transformed electrical power is further transmitted to a grid via bus 240, circuit breaker 238 and bus 242.

In the doubly-fed induction generator configuration, a second electrical power transmission path is provided. Electrical, three-phase, sinusoidal, AC power is generated within wound rotor 122 and is transmitted to assembly 210 via bus 212. Within assembly 210, the electrical power is transmitted to rotor filter 218 wherein the electrical power is modified for the rate of change of the PWM signals associated with converter 220. Converter 220 acts as a rectifier and rectifies the sinusoidal, three-phase AC power to DC power. The DC power is transmitted into DC link 244. Capacitor 250 facilitates mitigating DC link 244 voltage amplitude variations by facilitating mitigation of a DC ripple associated with AC rectification.

The DC power is subsequently transmitted from DC link 244 to power converter 222 wherein converter 222 acts as an inverter configured to convert the DC electrical power from DC link 244 to three-phase, sinusoidal AC electrical power with pre-determined voltages, currents, and frequencies. This conversion is monitored and controlled via controller 202. The converted AC power is transmitted from converter 222 to bus 216 via buses 227 and 225, line contactor 226, bus 230, circuit breaker 228, and bus 232. Line filter 224 compensates or adjusts for harmonic currents in the electric power transmitted from converter 222. Stator synchronizing switch 206 is configured to close such that connecting the three-phase power from stator 120 with the three-phase power from assembly 210 is facilitated.

Circuit breakers 228, 214, and 238 are configured to disconnect corresponding buses, for example, when current flow is excessive and can damage the components of the system 200. Additional protection components are also provided, including line contactor 226, which may be controlled to form a disconnect by opening a switch (not shown in FIG. 2) corresponding to each of the lines of the line bus 230.

Assembly 210 compensates or adjusts the frequency of the three-phase power from rotor 122 for changes, for example, in the wind speed at hub 110 and blades 108. Therefore, in this manner, mechanical and electrical rotor frequencies are decoupled and the electrical stator and rotor frequency matching is facilitated substantially independently of the mechanical rotor speed.

Under some conditions, the bi-directional characteristics of assembly 210, and specifically, the bi-directional characteristics of converters 220 and 222, facilitate feeding back at least some of the generated electrical power into generator rotor 122. More specifically, electrical power is transmitted from bus 216 to bus 232 and subsequently through circuit breaker 228 and bus 230 into assembly 210. Within assembly 210, the electrical power is transmitted through line contactor 226 and busses 225 and 227 into power converter 222. Converter 222 acts as a rectifier and rectifies the sinusoidal, three-phase AC power to DC power. The DC power is transmitted into DC link 244. Capacitor 250 facilitates mitigating DC link 244 voltage amplitude variations by facilitating mitigation of a DC ripple sometimes associated with three-phase AC rectification.

The DC power is subsequently transmitted from DC link 244 to power converter 220 wherein converter 220 acts as an inverter configured to convert the DC electrical power transmitted from DC link 244 to a three-phase, sinusoidal AC electrical power with pre-determined voltages, currents, and frequencies. This conversion is monitored and controlled via controller 202. The converted AC power is transmitted from converter 220 to rotor filter 218 via bus 219 is subsequently transmitted to rotor 122 via bus 212. In this manner, generator reactive power control is facilitated.

Assembly 210 is configured to receive control signals from controller 202. The control signals are based on sensed conditions or operating characteristics of wind turbine 100 and system 200 as described herein and used to control the operation of the power conversion assembly 210. For example, tachometer 204 feedback in the form of sensed speed of the generator rotor 122 may be used to control the conversion of the output power from rotor bus 212 to maintain a proper and balanced three-phase power condition. Other feedback from other sensors also may be used by system 200 to control assembly 210 including, for example, stator and rotor bus voltages and current feedbacks. Using this feedback information, and for example, switching control signals, stator synchronizing switch control signals and system circuit breaker control (trip) signals may be generated in any known manner. For example, for a grid voltage transient with predetermined characteristics, controller 202 will at least temporarily substantially suspend firing of the IGBTs within converters 220, 222. This process can also be referred to as “gating off” the IGBTs in converters 220, 222. Such suspension of operation of converters 220, 222 will substantially mitigate electric power being channeled through conversion assembly 210 to approximately zero.

Power converter assembly 210 and generator 118 may be susceptible to grid voltage fluctuations and other forms of grid faults. Generator 118 may store magnetic energy that can be converted to high currents when a generator terminal voltage decreases quickly. Those currents can mitigate life expectancies of components of assembly 210 that may include, but not be limited to, semiconductor devices such as the IGBTs within converters 220 and 222. Similarly, during an islanding event, generator 118 becomes disconnected from the grid. Components that comprise the electrical system 200 such as busses 208, 216, 232, 230, 236, 240 can store energy that is released during an islanding event. This can result in an overvoltage on the electrical system 200 that connects the generation unit 118 with the grid. An overvoltage can be a short-term or longer duration increase in the measured voltage of the electrical system over its nominal rating. For example, the overvoltage may be 1%, 5% 10%, 50%, 150% or greater, and any values therebetween, of the measured voltage over the nominal voltage. Another challenge presented to the electrical system 200 during an islanding event is that converter 210 and generator 118 may experience an extremely high impedance grid and will most likely have almost no ability to export real power. If the turbine is operating at a significant power level, that energy must be consumed, and there is a tendency for that energy to find its way into the DC link 244 that couples the two converters 220, 222, as described below. This power flow can occur into the DC link 244 by the power semiconductors (not shown in FIG. 2) of either the line 222 or rotor converter 220. For systems similar to the one shown in FIG. 2, the use of a crowbar circuit (e.g., a chopper circuit in series with a resistor), as known in the art, at the terminal of the rotor converter 220 may be used to protect the power semiconductors in many events, but the application of the crowbar during an islanding event may increase the risk of damage.

As noted above, overvoltage on the AC side of line side converter 222 can causes energy to be pumped into capacitors 250, thereby increasing the voltage on the DC link 244. The higher voltage on the DC link 244 can damage power semiconductors such as one or more electronic switches such as a gate turn-off (GTO) thyristor, gate-commutated thyristor (GCT), insulated gate bipolar transistor (IGBT), MOSFET, combinations thereof, and the like located within the line side converter 222 and/or rotor converter 220. The most obvious method to address the islanding event is to shut down both of the converters 220, 222 as soon as possible in order to de-excite the DFIG machine 118 and to open contactors 226, 206 in order to isolate the converter 210 and turbine from the grid. This method can be effective up to some range of grid capacitance, but in order to be effective, it must occur within a few milliseconds of the beginning of the islanding event. For high power cases, the required time of shutdown may be as little as 3 msec.

Grid faults can also include short-term current and/or voltage transients caused by various mechanisms including, for example, switching of the electrical system, phase to ground and phase to phase faults, open circuits, loads connected to the electrical system switching on and off, switching of electrical apparatus such as capacitors and transformers, and the like. These faults, unlike islanding, may be short term in nature and the electrical system may return to operation within normal parameters after a period of time. In some instances, such short-term faults can cause short term aberrations on the electrical system including high voltage, low voltage and zero voltage. These aberrations may also affect and/or damage the one or more electrical machines connected to the electrical system as well as one or more electronic switches such as a gate turn-off (GTO) thyristor, gate-commutated thyristor (GCT), insulated gate bipolar transistor (IGBT), MOSFET, combinations thereof, and the like located within the line side converter 222 and/or rotor converter 220. To protect the machines during these short term grid faults, various protection devices and methods have been developed to provide HVRT, ZVRT and LVRT, as described in U.S. Patent Publication U.S. 20120133343 A1 (U.S. application Ser. No. 13/323309) filed Dec. 12, 2011; U.S. Pat. No. 7,321,221 issued Jan. 22, 2008; and U.S. Pat. No. 6,921,985 issued Jul. 26, 2005, respectively, as described above and previously incorporated herein. In some instances, these HVRT, LVRT and ZVRT protection devices and methods involve the electrical machine outputting reactive current into the electrical system to facilitate the machine riding through the short term grid fault. However, in those first few milliseconds of a detected fault, it may be difficult to distinguish an islanding event from a high voltage event or other fault that is not caused by islanding. Many grid utility companies require or strongly desire wind farms to “ride through” high voltage events not caused by islanding. So, a challenge faced in the art is to allow the turbine to retain the capability to ride through faults such as a high voltage event (HVRT), and also to protect the converters and other turbine equipment for islanding events.

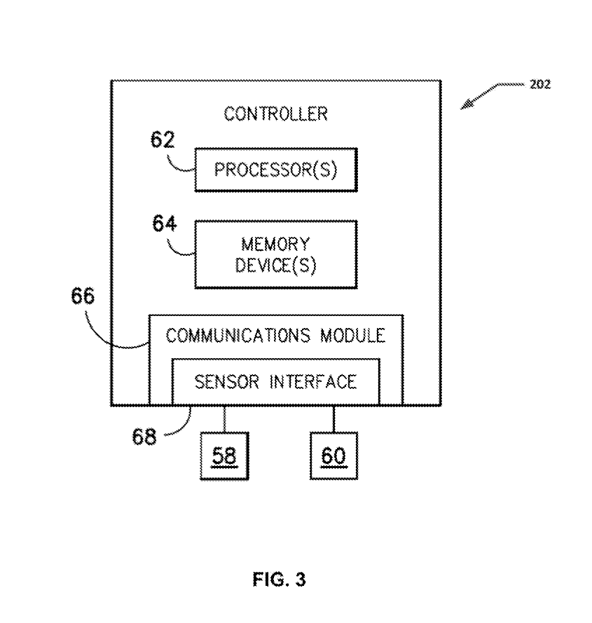

Referring now to FIG. 3, as noted above, some embodiments of systems for overvoltage protection can include a control system or controller 202. In general, the controller 202 may comprise a computer or other suitable processing unit. Thus, in several embodiments, the controller 202 may include suitable computer-readable instructions that, when implemented, configure the controller 202 to perform various different functions, such as receiving, transmitting and/or executing control signals. As such, the controller 202 may generally be configured to control the various operating modes (e.g., conducting or non-conducting states) of the one or more switches and/or components of embodiments of the electrical system 200. For example, the controller 200 may be configured to implement methods of protecting one or more electrical machines during a grid fault on an electrical system connected with the one or more electrical machines.

FIG. 3 illustrates a block diagram of one embodiment of suitable components that may be included within an embodiment of a controller 202, or any other computing device that receives signals indicating grid fault conditions in accordance with aspects of the present subject matter. In various aspects, such signals can be received from one or more sensors or transducers 58, 60, or may be received from other computing devices (not shown) such as a supervisory control and data acquisition (SCADA) system, a turbine protection system, PLL regulator 400 and the like. Received signals can include, for example, voltage signals such as DC bus 244 voltage and AC grid voltage along with corresponding phase angles for each phase of the AC grid, current signals, power flow (direction) signals, power output from the converter system 210, total power flow into (or out of) the grid, and the like. In some instances, signals received can be used by the controller 202 to calculate other variables such as changes in voltage phase angles over time, and the like. As shown, the controller 202 may include one or more processor(s) 62 and associated memory device(s) 64 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 64 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 64 may generally be configured to store suitable computer-readable instructions that, when implemented by the processor(s) 62, configure the controller 202 to perform various functions including, but not limited to, directly or indirectly transmitting suitable control signals to one or more switches that comprise the bi-directional power conversion assembly 210, monitoring operating conditions of the electrical system 200, and various other suitable computer-implemented functions.

Additionally, the controller 202 may also include a communications module 66 to facilitate communications between the controller 202 and the various components of the electrical system 200 and/or the one or more sources of electrical generation 118. For instance, the communications module 66 may serve as an interface to permit the controller 202 to transmit control signals to one or more switches that comprise the bi-directional power conversion assembly 210 to change to a conducting or non-conducting state. Moreover, the communications module 66 may include a sensor interface 68 (e.g., one or more analog-to-digital converters) to permit signals transmitted from the sensors (e.g., 58, 60) to be converted into signals that can be understood and processed by the processors 62. Alternatively, the controller 202 may be provided with suitable computer readable instructions that, when implemented by its processor(s) 62, configure the controller 202 to determine based on a first received indicator whether an islanding of the one or more sources of electrical generation 118 has occurred based on information stored within its memory 64 and/or based on an input received from the electrical system by the controller 202. Similarly, the controller 202 may be provided with suitable computer readable instructions that, when implemented by its processor(s) 62, configure the controller 202 to determine based on the one or more additional condition indicators whether a grid fault on an electrical system connected with the one or more electrical machines 118 has occurred based on information stored within its memory 64 and/or based on other inputs received from the electrical system 200 by the controller 202.

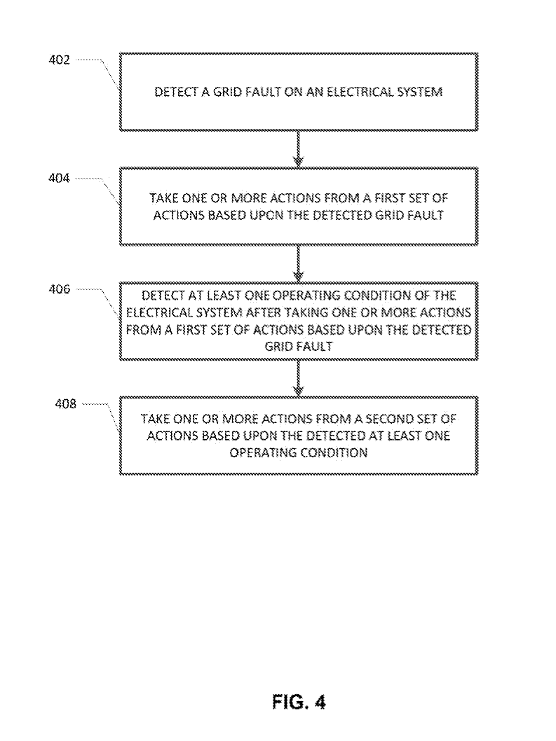

FIG. 4 is a flowchart illustrating an embodiment of a method of protecting one or more electrical machines during a grid fault on an electrical system connected with the one or more electrical machines such as wind turbine generators. Embodiments of steps of the method described in FIG. 4 can be performed by one or more computing devices such as controller 202. At step 402, a grid fault on an electrical system is detected by the computing device. In one aspect, detecting a grid fault on an electrical system comprises detecting one or more of an opening of one or more phases of the electrical system, an islanding of at least one of the one or more electrical machines from the electrical system, a low voltage on the electrical system, a high voltage on the electrical system, a zero voltage on the electrical system, and the like.

At step 404, one or more first actions can be taken by the computing device from a first set of actions based on the detected grid fault on the electrical system. For example, high AC voltage detected in the electrical system may be an indication of an islanding event or a high-voltage transient. In one aspect, taking one or more first actions from the first set of actions based on the detected grid fault on the electrical system comprises switching one or more switches of portions of the one or more electrical machines to a non-conducting state if the grid fault is a high-voltage event. For example, the computing device can take action to protect at least a portion of the one or more electrical machines by sending one or more signals to one or more switches that comprise at least a portion of the one or more electrical machines to place the switches in a non-conducting state. For example, these switches may comprise electronic switches in the rotor-side, bi-directional power converter 220 and/or the line-side, bi-directional power converter 222. For example, these switches may comprise one or more insulated gate bipolar transistors (IGBTs), gate turn-off (GTO) thyristors, gate-commutated thyristors (GCT), MOSFET, combinations thereof, and the like. By placing these switches in a non-conducting state, the rotor-side, bi-directional power converter 220, the line-side, bi-directional power converter 222 and the one or more electrical machines can be protected from overvoltages and transients caused by islanding of the one or more electrical machines or other causes of high-voltage.

In another aspect, the computing device can go into an interrogation mode based on the detected grid fault before gating off any switches and begin resisting a measured high voltage (e.g., AC grid voltage above a threshold (e.g., 120 percent) and/or DC overvoltage of the DC link 244 at or above a threshold (e.g., 1250 volts)). For example, once high voltage is detected, the event may be either an islanding event or a high voltage transient. In such instances, a flag may be set by the controller and several actions taken from a first set of actions based on the detected high voltage. Such actions may include, for example, switching the rotor converter control mode from normal to an “islanding” control mode that allows the generator to respond to real and reactive current commands; reducing the torque command to the rotor control to zero or near zero in order to reduce the amount of power being output by the generator and reducing the resulting real current command for the rotor converter to zero or near zero and using it in the islanding control mode; driving reactive current commands in a manner proportional to the magnitude of the detected AC voltage, but limited to the capability of the system; and, the line converter producing reactive current in order to reduce the AC voltage. If the electrical system includes a rotor crowbar, as known in the art, the rotor crowbar activation level is raised in order to reduce the probability of activating it; and a state machine or other similar control structure is activated to begin the process of sequencing the control through the event.

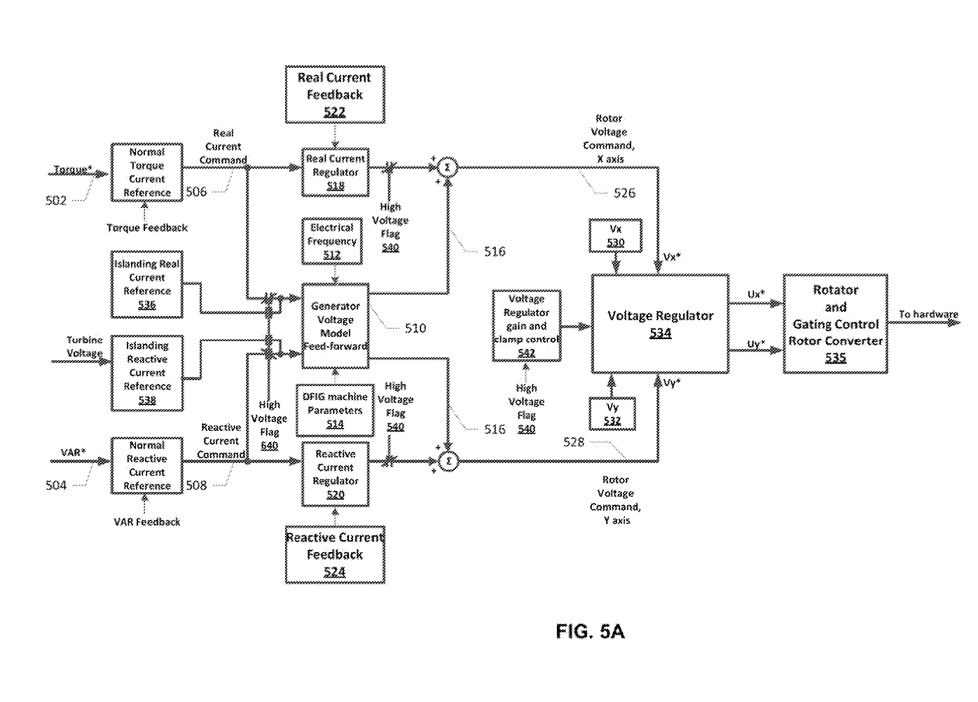

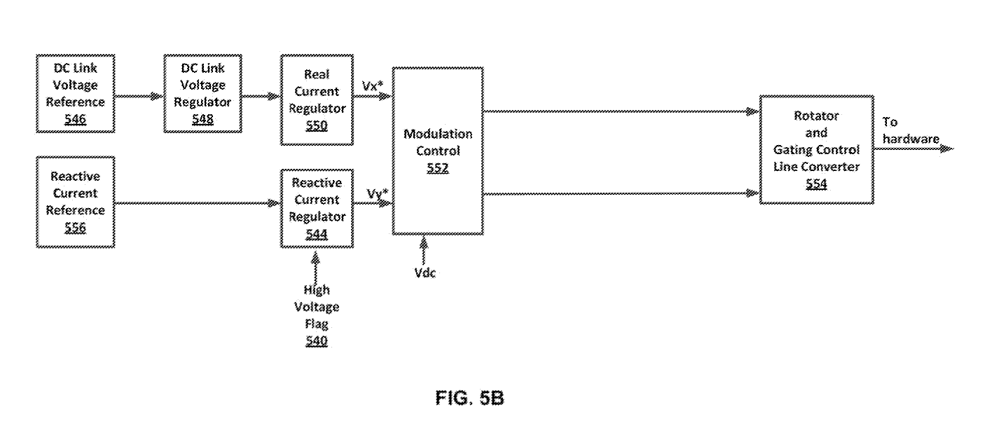

As mentioned above, if the detected grid fault involves a high voltage event, one of the one or more first actions that can be taken from the first set of actions based on the detected grid fault on the electrical system is switching the control to an islanding mode during the interrogation period. If the event proves to not be islanding, then the control mode can be switched back to the normal mode. Control action for islanding and HVRT control is primarily performed through the rotor converter 220 (FIG. 5A) because it has influence on the total power and VAR capability of the electrical system. FIG. 5A illustrates an exemplary control scheme for the rotor converter 220. However, FIG. 5B illustrates an exemplary control scheme of the line converter 222 because it can be used to control the reactive current in the electrical system. As shown in FIGS. 5A and 5B, in normal mode, torque 502 and VAR 504 commands are given to the rotor control and regulation of those two quantities is achieved by converting the torque 502 and VAR 504 commands to real 506 and reactive 508 current commands. A voltage feed-forward model 510 that uses the current commands, machine parameters 512, and electrical frequency 514 of the rotor outputs voltage feed-forward commands 516 which are close to voltage values needed to produce the voltages needed to achieve the requested currents. Real and reactive current regulators 518, 520 use feedbacks 522, 524 and PI controls to adjust the voltage commands 516 so that the required current is achieved. The outputs of the current regulators are rotor voltage commands 526, 528 that are used to compare to rotor voltage feedbacks 530, 532 in the rotor voltage regulator 534. The output of the rotor voltage regulator 534 is rotated and turned into bridge gating commands by a rotator and gating control 535 for the rotor convertor 220 for the rotor converter bridge. In normal mode, the rotor control then achieves the requested torque and VAR commands by the use of the above mentioned regulators and models. During an islanding event, the electrical system of the turbine changes because the grid characteristics have changed drastically from normal. Because of this the normal regulation mode is no longer effective and the need for the turbine is no longer to satisfy the requests of torque and VARs for the electrical system. In fact, the real power of the generator must be quickly reduced and reactive current must be used in order to reduce the voltage at the turbine. It is also useful to allow the line converter 222 to assist in the reduction of reactive current by temporarily allowing it to output more reactive current than would normally be allowed. The following techniques can be used in the control (FIG. 5A) to achieve these results. A “high voltage” flag 540 is used within the control to switch from normal mode to islanding mode and sometimes back as described below: (1) the generator feed-forward model 510 receives independent “islanding” current references 536, 538 rather than real 506 and reactive 508 current commands. Typically, the real current reference 536 is set to a very low or zero value in order to reduce the real current and thus the real power delivered by the generator. The reactive current reference 538, which is needed to reduce the high voltage at the turbine and also to de-excite the DFIG machine, is set to a value that is proportional to the value of the voltage once a threshold is reached; (2) the rotor current regulators 518, 520 are turned off when the high voltage flag is set; (3) the voltage regulator gains and clamps 542 are adjusted to facilitate better control during the event; and (4) the line converter reactive current regulator 544 (FIG. 5B) is enabled to produce more reactive current.

As shown in FIG. 5B, the control scheme of the line converter 222 comprises real and reactive current regulation paths. The upper, or real path shown in FIG. 5B is responsible for maintaining a dc link voltage. Regulation of the dc link voltage by the line converter 222 maintains the balance of power that insures that the rotor converter 220 is able to properly manage the excitation of the DFIG machine. The dc link voltage reference 546 determines the dc link voltage that the line converter 222 attempts to maintain. This dc voltage may be fixed or floating and may vary during certain conditions such as grid faults so as to best benefit the system. The dc link voltage regulator 548 is responsible for maintaining the dc link voltage reference by comparing the feedback of the dc link voltage to the reference 546 and developing a current command for the real current regulator 550 that will satisfy the reference 546. The real current regulator 550 then develops a line voltage command (Vx*) that satisfies the current command given by the dc link voltage regulator 548. This voltage command is turned into a modulation index for the modulation control 552 that is then passed to the rotator and gate control 554 to implement converter gating that will maintain the required dc link voltage reference 546. The lower path in FIG. 5B is responsible for maintaining a fixed or varying reactive current reference 556 that may be given by an outer loop or another controller. For instance, the line converter 222 may help the rotor converter 220 supply reactive current to the grid if necessary or the line converter 222 may act on its own as a VAR compensator in the absence of winds sufficient for generator operation. In either case, the reactive current reference 556 may clamp this reactive current command or limit the rate of change according to the converter's capability. The reactive current regulator 544 compares the commanded reactive current to the feedback or actual reactive current and produces a line voltage command (Vy*) in the “Y” axis that will satisfy the reactive current commands. The reactive current regulator 544 may also help the real current regulator 550 by providing supplemental reactive current when the real current regulator 550 is in limit. This supplemental reactive current can modify the relationship of the x and y voltage vectors in a way to help alleviate the limit condition of the real current regulator 550.

The high voltage flag 540 that is set during a high voltage event is used to transiently allow increased authority of the reactive current regulator 544 during high voltage events, regardless of whether the event is islanding or an HVRT. This additional transient capability can be used to aid the real current regulator 550, as mentioned above, or it can be used to allow an increased amount of reactive current through the reactive current reference 556. In either case, the transient increased reactive current capability can aid the line converter 222 in helping to supply reactive current to the system in order to help reduce the ac voltage seen during islanding or HVRT events.

If the control sequencer determines that the event is HVRT event after the initial transient, the high voltage flag 540 can be cleared and the control returns to its normal mode. The control can respond better to HVRT events and normal operation in its normal mode. The high voltage mode that is entered when the high voltage event first occurs offers the advantage of quick response to either type of event (islanding or HVRT), but after the initial transient is passed, response to a HVRT event can be better managed by the normal mode of control. The shift of control modes during a high voltage event may be advantageous over normal control methods even for those cases where the event is to be ridden through (not islanding). The converter is put in a mode (i.e., high voltage) that allows very fast reactive current response in a direction to reduce the ac voltage when that voltage rises quickly. The net result is a system that has increased ride-through capability for high voltage events for which it is desirable for the turbine to ride through. This can also provide an improved response for certain other types of conditions, such as single phase or three phase open events that affect only one turbine, such as loss of fuses or open breakers.

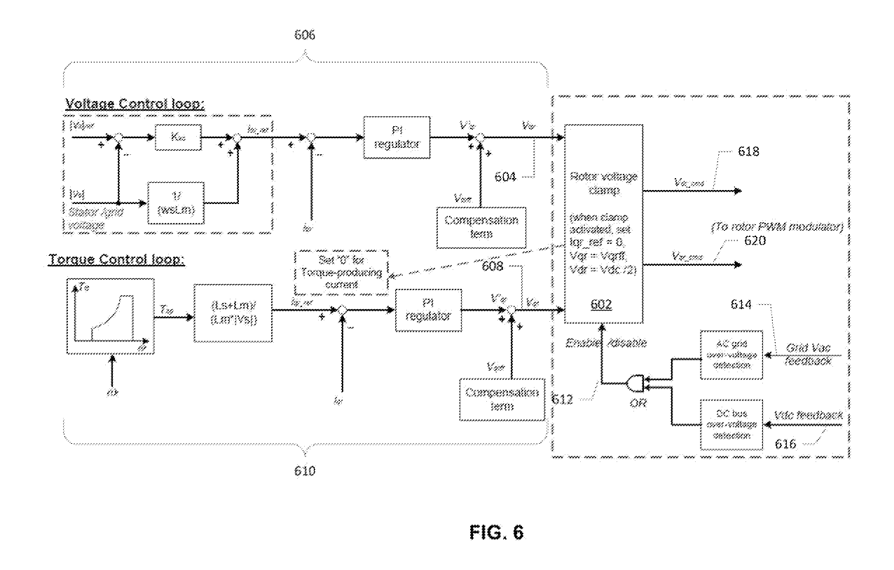

In one aspect, returning to FIG. 4, one of the one or more first actions that can be taken from the first set of actions based on the detected grid fault on the electrical system is resisting the measured high voltage, which can be performed by the computing device clamping excitation voltage of the electrical machine (e.g., wind turbine generator) to a value that is less than the value of excitation voltage when the overvoltage is detected. In one aspect, the excitation voltage can be clamped indirectly by using current commands that can be turned into rotor voltage commands via a model of the machine (e.g., wind turbine generator). For example, consider the control schematic of FIG. 6 as applied to the electrical and control scheme of FIG. 2. FIG. 5 illustrates an embodiment of a rotor voltage clamp control schematic for protecting a DFIG by clamping excitation voltage (Uy_cmd and Ux_cmd) of the rotor. By clamping the rotor excitation voltage (Uy_cmd and Ux_cmd), better transient magnetization control over excitation of the rotor air-gap flux can be obtained, and therefore suppress DFIG stator line AC voltage. In other words, the level of DFIG stator AC overvoltage is mitigated by gaining more control on the generator's magnetizing current and concurrently reducing motor torque control. This provides better capability to avoid tripping the DFIG because of events that the DFIG can ride through, and/or reduce DC bus voltage during open grid islanding events. As shown in FIG. 5, inputs to the clamping control logic (rotor voltage clamp) 602 include Vdr 604 from a voltage control loop 606 and Vqr 608 from a torque control loop 610 as well as an enable/disable command 612 for the clamping control logic 602 based on detection of an AC grid overvoltage (grid Vac feedback 614) or a DC bus overvoltage (Vdc feedback 616). Outputs of the clamping control logic 602 include Vdr_cmd 618 and Vqr_cmd, 620 which are used to set the Uy_cmd and Ux_cmd values of the rotor through a rotor pulse width modulator (PWM). In one aspect, the clamping control logic can set the following values in order to clamp excitation voltage: Iqr=0; Vqr=Vqr_ff, using only the feed-forward (ff) compensation term; and Vdr=Vdc/2, utilizing full DC bus voltage for magnetization control. In another aspect, excitation voltage may be clamped at fixed values such as, for example, Uy_cmd<0.5 and Ux_cmd<1.1. In one aspect, there can be a hysteresis band built in each detection trigger, both on AC grid over-voltage detection and the DC bus over-voltage detection. When both AC voltage and DC voltage have reduced below the threshold minus hysteresis, the controller can remove the rotor voltage clamp.

Returning to FIG. 4, in another aspect if the detected grid fault is not a high voltage event such as, for example, a low voltage or a zero voltage event, then taking one or more first actions by the computing device from a first set of actions based on the detected grid fault on the electrical system can comprise the computing device causing at least one of the one or more electrical machines to output reactive current into the electrical system if the grid fault comprises a low voltage ride-through (LVRT) event, or a zero voltage ride-through (ZVRT) event and/or taking actions as described in U.S. Patent Publication U.S. 20120133343 A1 (U.S. application Ser. No. 13/323309) filed Dec. 12, 2011; U.S. Pat. No. 7,321,221 issued Jan. 22, 2008; and U.S. Pat. No. 6,921,985 issued Jul. 26, 2005, respectively, as described above and previously incorporated herein.

At step 406, the computing device receives input signals from various monitors, transducers, devices, other computing devices, and the like associated with the electrical system and detects at least one operating condition of the electrical system after taking one or more first actions from the first set of actions based on the detected grid fault on the electrical system. In one aspect, detecting the at least one operating condition of the electrical system after taking one or more first actions from the first set of actions based on the detected grid fault on the electrical system comprises determining whether one or more operating parameters of the electrical system are within acceptable operating ranges. In various aspects, the one or more operating parameters can include voltage, current, real power, reactive power, frequency, direction of power flow, phase angle, reactance, impedance, capacitance, resistance, inductance, and the like. For example, in one aspect, the controller examines the frequency of the electrical system as determined by, for example, the PLL (phase lock loop). If the measured frequency of the system is outside the nominal value by a predetermined amount, the system determines an ‘islanding’ event is in process. In one aspect, the determination of islanding can be performed using a filtered version of a frequency that achieves a fixed threshold. In another aspect, once a high voltage is sensed, a delta or change in frequency can be used to detect an islanding event. Other methods of determining islanding may also be employed, such as phase-jump, reverse power detection, and the like. For example, determining whether an islanding of at least one of the one or more electrical machines from the electrical system has occurred can comprise receiving a first indicator of an islanding of one or more electrical machines. Generally, this indicator is received by a computing device such as controller 202. In one aspect, this first indicator can be an indication of a voltage phase angle jump at, for example, the system bus 216 or the grid bus 242. The phase angle jump is a rapid change in the voltage phase angle of one or more phases of the AC voltage at, for example, the system bus 216 or the grid bus 242. Phase angle jump is determined by measuring real time phase angle displacement compared to its previous phase angle over a defined time period. If phase displacement error is higher than a threshold (in either positive or negative direction), a phase jump error can be declared. In one aspect, voltage phase angle is tracked, in real time, for one or more phases using the PLL regulator 400. A change in the tracked phase angle creates an output from the PLL regulator indicating a phase angle jump. In another aspect, the first indicator can comprise an amplitude overvoltage at the system bus 216 or the grid bus 242 or even the DC bus 244. In another aspect, the first indicator of islanding can comprise a change in frequency on one or more phases of the system bus 216 or the grid bus 242. In particular, rapid changes in frequency may indicate islanding of the one or more electrical machines. In yet another aspect, the first indicator of islanding can include a signal from the AC grid circuit breaker 238 indicating the breaker has opened. In one aspect, the computing device can make a determination that islanding has occurred if the voltage phase angle jump exceeds approximately plus or minus 30 degrees. In another aspect, if the voltage phase angle jump does not exceed approximately plus or minus 30 degrees, but an overvoltage of 125% or greater is detected at the system bus 216 or the grid bus 242 or even the DC bus 244, then the computing device can make a determination that islanding has occurred. It is to be appreciated that these thresholds are exemplary only and can be adjusted as desired in order to protect at least a portion of the one or more electrical machines, any other values for such thresholds are contemplated within the scope of embodiments of the present invention. Furthermore, if the first indicator does not clearly indicate the islanding of at least one of the one or more electrical machines, then one or more additional condition indicators can be received by the computing device. These one or more additional condition indicators can be, for example, one or more of an indication of an overvoltage on an alternating current (AC) electric power system 200 connected to the one or more electrical machines, an indication of an overvoltage on the DC bus 244, an indication of reverse power flow through the line side converter 222, an indication of an excessive magnitude of power flow through the line side convertor 222 or the rotor convertor 220, and the like. In one aspect, the first indicator in combination with the one or more additional indicators can be used by the computing device to make a determination whether the grid fault is an islanding event. For example, the voltage phase angle jump in combination with at least one of an indication of an overvoltage on an alternating current (AC) electric power system connected to the one or more electrical machines, an indication of an overvoltage on the DC bus, an indication of reverse power flow through the line side converter, an indication of a magnitude of power flow through the line side convertor or the rotor convertor and the like can be used by the computing device to determine whether the grid fault was an islanding event. Consider one non-limiting example, if the voltage phase angle jump is less than or equal to approximately 30 degrees or equal to or greater than negative 30 degrees and the indication of the overvoltage on an alternating current (AC) electric power system connected to the one or more electrical machines indicates the overvoltage is approximately 125 percent or greater than nominal voltage, then the computing device can determine that the grid fault is an islanding event. Similarly, inputs from the electrical system to the computing device can be used to determine whether the grid fault comprises a high voltage ride-through (HVRT) event. For example, if the electrical system is experiencing high voltage yet the measured frequency of the system is within the allowed range by a predetermined amount, the controller determines that a high voltage transient event is in process, and the converter control may return to its normal mode to facilitate ride through of the event as a high voltage event (HVRT), as described herein.

At step 408, the computing device takes one or more second actions from a second set of actions based on the detected at least one operating condition of the electrical system. In one aspect, taking the one or more second actions from the second set of actions based on the detected at least one operating condition of the electrical system comprises shutting down at least one of the one or more electrical machines if one or more operating parameters of the electrical system are not within acceptable operating ranges. For example, if the system is experiencing a high voltage event and the measured frequency of the system is outside the nominal value by a predetermined amount, the system determines an islanding event is in process and the following exemplary actions from the second set of actions can be taken: (a) the synchronizing contactor and the turbine breaker are sent commands to open; (b) fundamental frequency is controlled in an attempt to prevent VAR loading of the system, which is proportional to frequency, from increasing; (c) control of the gating of the converters continues in a manner to follow the islanding control method until the turbine is isolated from the grid and the synchronizing contactor is open, for example, for certain trip faults, like high voltage trips, the breaker separating the turbine from the grid can be commanded to open as soon as the trip is detected, but the converters continue to run and provide reactive current to the grid until the breaker has opened; (d) the converters are shut down; and (d), an annunciation is made that an islanding event has occurred. If the electrical system includes a rotor crowbar, as known in the art, in one aspect activation of the rotor crowbar can be suspended once islanding is detected. In another aspect, taking the one or more second actions from the second set of actions based on the detected at least one operating condition of the electrical system comprises synchronizing at least one of the one or more electrical machines with the electrical system and switching the one or more switches of portions of the one or more electrical machines to a conducting state if one or more operating parameters of the electrical system are within acceptable operating ranges.

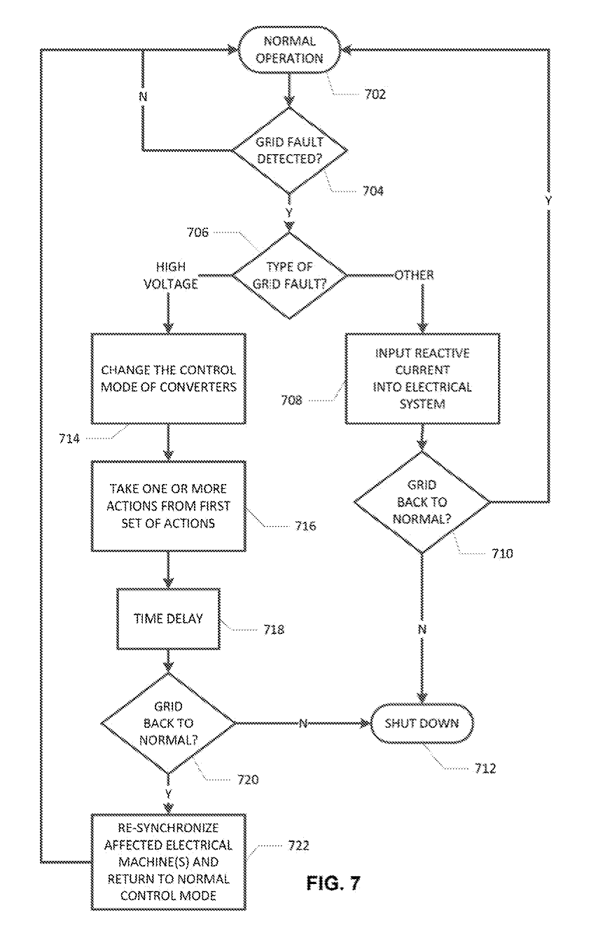

FIG. 7 is a flowchart illustrating another embodiment of a method of protecting one or more electrical machines during a grid fault on an electrical system connected with the one or more electrical machines such as wind turbine generators. Embodiments of steps of the method described in FIG. 7 can be performed by one or more computing devices such as controller 202. At step 702, the electrical machine is operating normally—all monitored or measured operating parameters for the one or more electrical machines or the AC electric power system connected to the one or more electrical machines are within acceptable ranges. At step 704, it is determined whether a grid fault is detected on an electrical system by the computing device. If a grid fault is not detected, then the process returns to step 702. In one aspect, detecting a grid fault on an electrical system comprises detecting one or more of an opening of one or more phases of the electrical system, an islanding of at least one of the one or more electrical machines from the electrical system, a low voltage on the electrical system, a high voltage on the electrical system, a zero voltage on the electrical system, and the like. If a grid fault is detected, then the process goes to step 706. At step 706, the type of grid fault is determined by the computing device. In one aspect, determining a type of the grid fault on the electrical system comprises determining whether the grid fault comprises a high voltage event or some other type of event. If high voltage, the event may be detected on the AC system and/or on the DC link of the electrical system. For example, a high voltage detection may indicate an islanding event, a high voltage ride-through (HVRT) event, and the like. Examples of other types of events can include a low voltage ride-through (LVRT) event, a zero voltage ride-through (ZVRT) event, and the like. If, at step 706, the grid fault comprises an other type event such as a LVRT or ZVRT event, then methods for ZVRT and LVRT such as those described in U.S. Pat. No. 7,321,221 issued Jan. 22, 2008; and U.S. Pat. No. 6,921,985 issued Jul. 26, 2005, respectively, previously incorporated herein by reference and made a part hereof can be employed. Such methods can include going to step 708 where, in one aspect, reactive current is input into the electrical system. In one aspect, the reactive current is input into the electrical system by at least one of the one or more electrical machines connected to the electrical system. For example, if the electrical machine is a synchronous generator, it may be over-excited in order to produce reactive current. In other aspects, reactive current may be provided by other devices and methods such as, for example, capacitors and/or the converters. At step 710, it is determined whether the electrical system is back to normal after having experienced the grid fault. In one aspect, this can be performed by the computing device receiving input signals from various monitors, transducers, devices, other computing devices, and the like associated with the electrical system and detecting at least one operating condition of the electrical system after inputting reactive current into the electrical system at step 708. In one aspect, detecting the at least one operating condition of the electrical system after inputting reactive current into the electrical system comprises determining whether one or more operating parameters of the electrical system are within acceptable operating ranges. In various aspects, the one or more operating parameters can include voltage, current, real power, reactive power, frequency, direction of power flow, phase angle, reactance, impedance, capacitance, resistance, inductance, and the like. If, at step 710, the electrical system is back to normal, then the process returns to step 702. However, if, at step 710, the electrical system is not back to normal, then at step 712 the computing device begins shutting down at least one of the one or more electrical machines and ancillary equipment that is connected to the electrical system, as described herein.

Returning to step 706, if the grid fault is a high voltage event that may be associated with an open grid or islanding, as described herein, then the process goes to step 714. At step 714, computing device can take action to protect at least a portion of the one or more electrical machines. In one aspect, this can involve changing the control mode of one or more of the converters 220, 222. For example, in one aspect, changing the control mode comprises changing the converter control from a normal mode to an islanding mode, as described herein, to a protection mode or to an interrogation mode.

At step 716, one or more first actions can be taken by the computing device from a first set of actions based on the detected grid fault on the electrical system. For example, high AC voltage detected in the electrical system may be an indication of an islanding event or a high-voltage transient. In one aspect, taking one or more first actions from the first set of actions based on the detected grid fault on the electrical system comprises switching one or more switches of portions of the one or more electrical machines to a non-conducting state if the grid fault is a high-voltage event. For example, the computing device can take action to protect at least a portion of the one or more electrical machines by sending one or more signals to one or more switches that comprise at least a portion of the one or more electrical machines to place the switches in a non-conducting state. For example, these switches may comprise electronic switches in the rotor-side, bi-directional power converter 220 and/or the line-side, bi-directional power converter 222. For example, these switches may comprise one or more insulated gate bipolar transistors (IGBTs), gate turn-off (GTO) thyristors, gate-commutated thyristors (GCT), MOSFET, combinations thereof, and the like. By placing these switches in a non-conducting state, the rotor-side, bi-directional power converter 220, the line-side, bi-directional power converter 222 and the one or more electrical machines can be protected from overvoltages and transients caused by islanding of the one or more electrical machines or other causes of high-voltage.

In another aspect, the computing device can go into an interrogation mode based on the detected grid fault before gating off any switches and begin resisting a measured high voltage (e.g., AC grid voltage above a threshold (e.g., 120 percent) and/or DC overvoltage of the DC link 244 at or above a threshold (e.g., 1250 volts)). For example, once high voltage is detected, the event may be either an islanding event or a high voltage transient. In such instances, a flag may be set by the controller and several actions taken from a first set of actions based on the detected high voltage. Such actions may include, for example, (a) switching the rotor converter control mode from normal to an “islanding” control mode that allows the generator to respond to real and reactive current commands; (b) reducing the torque command to the rotor control to zero or near zero in order to reduce the amount of power being output by the generator and reducing the resulting real current command for the rotor converter to zero or near zero and using it in the islanding control mode, for example, in one aspect the torque producing current to the generator may be taken to a value that is about 10 percent of rated real current in the “motoring” direction. This action can help to more quickly demagnetize the machine; (c) driving reactive current commands in a manner proportional to the magnitude of the detected AC voltage, but limited to the capability of the system; and, (d) the line converter producing reactive current in order to reduce the AC voltage. If the electrical system includes a rotor crowbar, as known in the art, the rotor crowbar activation level is raised in order to reduce the probability of activating it; and a state machine or other similar control structure is activated to begin the process of sequencing the control through the event. In one aspect activation of the rotor crowbar can be suspended once islanding is detected.

In another aspect, the converter can be placed in a protection mode that can include changing the operational characteristics and/or gating off switches that comprise the converters 220, 222, as described herein. In one aspect, this control mode of one or more of the converters 220, 222 comprises changing the firing characteristics of electronic switches that comprise the converters 220, 222. For example, the angle at which the electronic switch fires may be altered. In another aspect, one or more signals can be sent to one or more switches that comprise at least a portion of the one or more electrical machines to place the switches in a non-conducting state. For example, these switches may comprise electronic switches in the rotor-side, bi-directional power converter 220 and/or the line-side, bi-directional power converter 222. For example, these switches may comprise one or more IGBTs, GTO thyristors, GCT, MOSFET, combinations thereof, and the like. By changing the firing characteristics and/or gating off these switches, the rotor-side, bi-directional power converter 220, the line-side, bi-directional power converter 222 and the one or more electrical machines can be protected from overvoltages and transients caused by islanding of the one or more electrical machines.

At step 720, it is determined whether the electrical system is back to normal after having experienced the grid fault. In one aspect, this can be performed by the computing device receiving input signals from various monitors, transducers, devices, other computing devices, and the like associated with the electrical system and detecting at least one operating condition of the electrical system after having changed the control mode of converters associated with the one or more electrical machines at step 714 and performing the one or more actions from a first set of actions at step 716. In one aspect, detecting the at least one operating condition of the electrical system comprises determining whether one or more operating parameters of the electrical system are within acceptable operating ranges. In various aspects, the one or more operating parameters can include voltage, current, real power, reactive power, frequency, direction of power flow, phase angle, reactance, impedance, capacitance, resistance, inductance, and the like. In one aspect, the process described is performed after a time delay (step 718) that allows the electrical system to stabilize; however, this step is optional and is not required to practice embodiments of the present invention. If, at step 720, the electrical system is back to normal, then the process goes to step 722. However, if, at step 720, the electrical system is not back to normal, then at step 712 the computing device begins shutting down at least one of the one or more electrical machines and ancillary equipment that is connected to the electrical system, as described herein.

At step 722, the one or more electrical machines that were affected at steps 714 and 716 are re-synchronized with the electrical system and the control mode of the converters is returned to a normal control mode (e.g., the one or more switches that were placed in the non-conducting state are placed in a conducting state and other actions as described above), and the process returns to step 702.

As described above and as will be appreciated by one skilled in the art, embodiments of the present invention may be configured as a system, method, or a computer program product. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable non-transitory computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as the processor(s) 62 discussed above with reference to FIG. 3, to produce a machine, such that the instructions which execute on the computer or other programmable data processing apparatus create a means for implementing the functions specified in the flowchart block or blocks.

These computer program instructions may also be stored in a non-transitory computer-readable memory that can direct a computer or other programmable data processing apparatus (e.g., processor(s) 62 of FIG. 3) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method of protecting one or more electrical machines during a grid fault on an electrical system connected with the one or more electrical machines, said method comprising:
detecting a grid fault on an electrical system, wherein detecting the grid fault on the electrical system comprises detecting whether the grid fault comprises a high voltage event or another grid fault event;
taking one or more first actions from a first set of actions based on the detected grid fault on the electrical system;
detecting at least one operating condition of the electrical system after taking one or more first actions from the first set of actions based on the detected grid fault on the electrical system; and
taking one or more second actions from a second set of actions based on the detected at least one operating condition of the electrical system.

2. The method of claim 1, wherein detecting a grid fault on an electrical system comprises detecting one or more of an opening of one or more phases of the electrical system, an islanding of at least one of the one or more electrical machines from the electrical system, a low voltage on the electrical system, a high voltage on the electrical system, or a zero voltage on the electrical system.

3. The method of claim 1, wherein taking one or more first actions from the first set of actions based on the detected grid fault on the electrical system comprises changing a control mode of at least portions of the one or more electrical machines based on the detected grid fault.

4. The method of claim 3, wherein the detected grid fault is a high-voltage event and taking one or more first actions from the first set of actions based on the detected grid fault on the electrical system further comprises switching one or more switches of portions of the one or more electrical machines to a non-conducting state, or switching the control mode from a normal mode to an islanding control mode that allows the one or more electrical machines to respond to real and reactive current commands and reducing a torque command to a rotor control associated with the one or more electrical machines to zero or near zero, reducing a resulting real current command for a rotor converter associated with the one or more electrical machines to zero or near zero and using it in the islanding control mode, driving reactive current commands in a manner proportional to a magnitude of the detected high voltage but limited to a capability of the electrical system, and producing, by a line converter associated with the one or more electrical machines, reactive current in order to reduce the high voltage.

5. The method of claim 1, wherein detecting the at least one operating condition of the electrical system after taking one or more first actions from the first set of actions based on the detected grid fault on the electrical system comprises determining whether one or more operating parameters of the electrical system are within acceptable operating ranges.

6. The method of claim 5, wherein the one or more operating parameters include voltage, current, real power, reactive power, frequency, direction of power flow, phase angle, reactance, impedance, capacitance, resistance and inductance.

7. The method of claim 5, wherein taking one or more second actions from the second set of actions based on the detected at least one operating condition of the electrical system comprises shutting down at least one of the one or more electrical machines if one or more operating parameters of the electrical system are not within acceptable operating ranges, or synchronizing at least one of the one or more electrical machines with the electrical system and changing a control mode of portions of the one or more electrical machines to a normal mode if one or more operating parameters of the electrical system are within acceptable operating ranges.

8. A method of protecting one or more electrical machines during a grid fault on an electrical system connected with the one or more electrical machines, said method comprising:
connecting one or more electrical machines to an alternating current (AC) electric power system, wherein the AC electric power system is configured to transmit at least one phase of electrical power to the one or more electrical machines or to receive at least one phase of electrical power from the one or more electrical machines;
electrically coupling at least a portion of a control system to at least a portion of the AC electric power system;
coupling at least a portion of the control system in electronic data communication with at least a portion of the one or more electrical machines;
detecting a grid fault of the AC electric power system based on one or more conditions monitored by the control system wherein detecting the grid fault on the electrical system comprises detecting whether the grid fault comprises a high voltage or another grid fault event;
taking one or more first actions, by the control system, from a first set of actions based on the detected grid fault on the AC electric power system;
detecting, by the control system, at least one operating condition of the AC electric power system after taking one or more first actions from the first set of actions based on the detected grid fault on the AC electric power system; and
taking one or more second actions, by the control system, from a second set of actions based on the at least one detected operating condition of the AC electric power system.

9. The method of claim 8, wherein taking one or more first actions, by the control system, from the first set of actions based on the detected grid fault on the AC electric power system comprises changing a control mode of at least portions of the one or more electrical machines based on the detected grid fault.

10. The method of claim 9, wherein the detected grid fault is a high-voltage event and taking one or more first actions from the first set of actions based on the detected grid fault on the electrical system further comprises switching one or more switches of portions of the one or more electrical machines to a non-conducting state, or switching the control mode from a normal mode to an islanding control mode that allows the one or more electrical machines to respond to real and reactive current commands and reducing a torque command to a rotor control associated with the one or more electrical machines to zero or near zero, reducing a resulting real current command for a rotor converter associated with the one or more electrical machines to zero or near zero and using it in the islanding control mode, driving reactive current commands in a manner proportional to a magnitude of the detected high voltage but limited to a capability of the electrical system, and producing, by a line converter associated with the one or more electrical machines, reactive current in order to reduce the high voltage.

11. The method of claim 8, wherein detecting, by the control system, at least one operating condition of the AC electric power system after taking one or more first actions from the first set of actions based on the detected grid fault on the AC electric power system comprises determining, by the control system, whether one or more operating parameters of the AC electric power system are within acceptable operating ranges.

12. The method of claim 11, wherein the one or more operating parameters include voltage, current, real power, reactive power, frequency, direction of power flow, phase angle, reactance, impedance, capacitance, resistance and inductance.

13. The method of claim 12, wherein taking, by the control system, one or more second actions from the second set of actions based on the detected at least one operating condition of the AC electric power system comprises shutting down at least one of the one or more electrical machines if one or more operating parameters of the AC electric power system are not within acceptable operating ranges, or synchronizing at least one of the one or more electrical machines with the AC electric power system and changing a control mode of portions of the one or more electrical machines to a normal mode if one or more operating parameters of the AC electric power system are within acceptable operating ranges.

14. A system for protecting one or more electrical machines during a grid fault on an electrical system connected with the one or more electrical machines, said system comprising:
one or more electrical machines connected to an alternating current (AC) electric power system, wherein the AC electric power system is configured to transmit at least one phase of electrical power to the one or more electrical machines or to receive at least one phase of electrical power from the one or more electrical machines; and
a control system, wherein the control system is electrically coupled to at least a portion of the AC electric power system and at least a portion of the control system is coupled in electronic data communication with at least a portion of the one or more electrical machines, and wherein said control system comprises a controller and said controller is configured to:
detect a grid fault on an the AC electric power system, wherein the controller configured to detect the grid fault on the AC electric system comprises the controller configured to detect whether the grid fault comprises a high voltage event or another grid fault event;
take one or more first actions from a first set of actions based on the detected grid fault on the electrical system;
detect at least one operating condition of the AC electric power system after taking one or more first actions from the first set of actions based on the detected grid fault on the AC electric power system; and
take one or more second actions from a second set of actions based on the detected at least one operating condition of the AC electric power system.

15. The system of claim 14, wherein the controller configured to detect a grid fault on the AC electric power system comprises the controller configured to detect one or more of an opening of one or more phases of the AC electric power system, an islanding of at least one of the one or more electrical machines from the AC electric power system, a low voltage on the AC electric power system, a high voltage on the AC electric power system, or a zero voltage on the AC electric power system.

16. The system of claim 14, wherein the controller configured to take one or more first actions from the first set of actions based on the detected grid fault on the AC electric power system comprises the controller configured to change a control mode of portions of the one or more electrical machines based on the detected grid fault.

17. The system of claim 16, wherein the detected grid fault is a high-voltage event and the controller configured to take one or more first actions from the first set of actions based on the detected grid fault on the electrical system further comprises the controller configured to switch one or more switches of portions of the one or more electrical machines to a non-conducting state, or switch the control mode from a normal mode to an islanding control mode that allows the one or more electrical machines to respond to real and reactive current commands and reducing a torque command to a rotor control associated with the one or more electrical machines to zero or near zero, reduce a resulting real current command for a rotor converter associated with the one or more electrical machines to zero or near zero and using it in the islanding control mode, drive reactive current commands in a manner proportional to a magnitude of the detected high voltage but limited to a capability of the electrical system, and produce, by a line converter associated with the one or more electrical machines, reactive current in order to reduce the high voltage.

18. The system of claim 14, wherein the controller configured to detect at least one operating condition of the AC electric power system after taking one or more first actions from the first set of actions based on the detected grid fault on the AC electric power system comprises the controller configured to determine whether one or more operating parameters of the AC electric power system are within acceptable operating ranges.

19. The system of claim 18, wherein the one or more operating parameters include voltage, current, real power, reactive power, frequency, direction of power flow, phase angle, reactance, impedance, capacitance, resistance and inductance.

20. The system of claim 18, wherein the controller configured to take one or more second actions from the second set of actions based on detected operating condition of the AC electric power system comprises shutting down at least one of the one or more electrical machines if one or more operating parameters of the AC electric power system are not within acceptable operating ranges, or synchronizing at least one of the one or more electrical machines with the AC electric power system and changing a control mode of portions of the one or more electrical machines to a normal mode if one or more operating parameters of the AC electric power system are within acceptable operating ranges.
